(19) United States
(12) Patent Application Publication
(10) Pub. No.: US 2015/0103778 A1
(43) Pub. Date: Apr. 16, 2015

(54) COOPERATION MULTI-INPUT MULTI-OUTPUT TRANSMITTING OR RECEIVING METHOD

(71) Applicant: ELECTRONICS AND TELECOMMUNICATIONS RESEARCH INSTITUTE, Daejeon (KR)

(72) Inventors: Seokki KIM, Daejeon (KR); Sung Cheol CHANG, Daejeon (KR); Seungkwon CHO, Daejeon (KR); Soojung JUNG, Daejeon (KR); Hyung Jin KIM, Daejeon (KR); Hyun LEE, Daejeon (KR); DongSeung KWON, Daejeon (KR)

(73) Assignee: ELECTRONICS AND TELECOMMUNICATIONS RESEARCH INSTITUTE, Daejeon (KR)

(21) Appl. No.: 14/507,875

(22) Filed: Oct. 7, 2014

(30) Foreign Application Priority Data
Oct. 11, 2013 (KR) 10-2013-0121509
Sep. 11, 2014 (KR) 10-2014-0120354

(51) Int. Cl. H04B 7/02; H04W 52/24; H04W 72/08; H04B 7/04

(52) U.S. Cl. CPC H04B 7/024; H04B 7/0413; H04W 52/244; H04W 72/082; H04W 72/10
USPC 370/329

(57) ABSTRACT

A cooperation MIMO transmitting or receiving method is disclosed. A master terminal calculates a first signal to interference plus noise ratio (SINR), which is SINR between the mater terminal and a base station or between the master terminal and another cluster, and the master terminal calculates a second SINR, which is SINR between a slave terminal and the master terminal. Here, the master terminal forms a cluster with the slave terminal when the second SINR is higher than the first SINR.

### CROSS-REFERENCE TO RELATED APPLICATION

This application claims priority to and the benefit of Korean Patent Application No. 10-2013-0121509 and 10-2014-0120354 filed in the Korean Intellectual Property Office on Oct. 11, 2013 and Sep. 11, 2014, the entire contents of which are incorporated herein by reference.

### BACKGROUND OF THE INVENTION

(a) Field of the Invention

The present invention relates to a cooperation multi-input multi-output (MIMO) transmitting or receiving method.

(b) Description of the Related Art

In accordance with rapid prevalence of smart mobile devices, wireless data traffic has been significantly increased, and in order to solve this problem, various methods for increasing transmission capacity in a wireless communications network have been suggested. A multi-input multi-output (MIMO) transmitting or receiving method using multiple antennas is a technology capable of increasing the transmission capacity in proportion to the number of antennas of a transceiver without using an additional frequency resource. In order to increase capacity of a wireless channel using the MIMO transmitting or receiving method, inter-channel correlation of each transmitting or receiving antenna should be small. To this end, a distance between the antennas should be increased, but there is a limit in increasing the distance between the antennas due to miniaturization of the smart device.

In order to overcome the limit of the above-mentioned MIMO transmitting or receiving method, a method has been suggested in which a plurality of adjacent apparatuses configure a cluster and channel capacity is increased by a cooperation MIMO transmission or reception between the clusters. The plurality of apparatuses configuring the cluster share transmitted or received data to perform the cooperation MIMO transmission or reception. Therefore, an additional resource in addition to the resource for the cooperation MIMO transmission or reception is required. As an amount of the above-mentioned additional resource is increased, an effect of a capacity increase achieved by the cooperation MIMO transmission or reception will be offset. Therefore, in order to increase substantial capacity by the cooperation MIMO transmission or reception, the resource which is additionally used to share the transmitted or received data in the cluster should be minimized. A usage of the additional resource may be reduced by a frequency reuse, but as a frequency reuse rate is increased, strength of an interference signal is also increased, such that reception performance may be degraded. In order to prevent the degradation of the reception performance while maintaining the capacity increase by the cooperation MIMO transmission or reception, an interference control technology for the cooperation MIMO transmission or reception is required.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide an efficient interference control method in cooperation multi-input multi-output (MIMO) transmission or reception.

An exemplary embodiment of the present invention provides a method of transmitting or receiving first data to be transmitted to a first apparatus or to be received from the first apparatus using cooperation communication by a first terminal. The method may include calculating a first signal to interference plus noise ratio (SINR), which is SINR between the first terminal and the first apparatus; calculating a second SINR, which is SINR between at least one second terminal and the first terminal performing the cooperation communication; and forming a first cluster with the second terminal to perform the cooperation communication when the second SINR is higher than the first SINR by a predetermined threshold or more.

The forming of the first cluster may include adjusting transmission power of the first data so that the second SINR is higher than the first SINR by the threshold or more.

The method may further include sharing the first data with the second terminal at the adjusted transmission power.

The first apparatus may be a base station to which the first terminal and the second terminal belong.

The first terminal may reuse a resource for communication between a second cluster and the base station in order to communicate with the second terminal, and

the second cluster may belong to the base station and may be a cluster which is different from the first cluster.

The first apparatus may be a second cluster which is different from the first cluster, and the first cluster and the second cluster may form a distributed environment.

Another embodiment of the present invention provides a method of allocating resources to a plurality of clusters performing cooperation communication by a base station. The method may include estimating location information for each of the plurality of clusters; determining a priority for each of the plurality of clusters based on the estimated location information; and allocating a resource for inter-cluster transmission to each of the plurality of clusters based on the priority.

The determining of the priority may include setting a higher priority to clusters which are more adjacent to each other among the plurality of clusters.

The allocating of the resources may include allocating different resources to a first cluster and a second cluster and allocating the same resource as that of the first cluster or the second cluster to a third cluster when a distance between the first cluster and the second is closer than a distance between the first cluster and the third cluster.

The estimating of the location information may include estimating the location information for each of the plurality of clusters using global positioning system (GPS) information or channel quality indicator (CQI) information of terminals belonging to each of the plurality of clusters.

Each of the plurality of clusters may perform the cooperation communication by sharing data to be transmitted to the base station or to be received from the base station between terminals belonging to a cluster.

Yet another embodiment of the present invention provides a method of operating a second terminal performing cooperation communication with a first terminal. The method may include measuring a first value which is strength of a signal received from the first terminal; measuring a second value which is strength of an interference signal received by the second terminal; and performing the cooperation communication when a ratio of the first value and the second value is a predetermined threshold or more.

The method may further include not performing the cooperation communication when the first value is a predetermined value or less.

The method may further include not performing the cooperation communication when the ratio of the first value and the second value is the predetermined threshold or less.

The threshold may be set to be different depending on a network environment.

According to an embodiment of the present invention, interference which may occur upon the cooperation MIMO transmission or reception in the cellular network environment or the wireless distributed network environment may be effectively controlled.

### BRIEF DESCRIPTION OF THE DRAWINGS

FIG. 1 is a drawing showing a kind of interference which may occur when performing cooperation MIMO transmission or reception with a cellular network environment according to an exemplary embodiment of the present invention.

FIG. 2 is a drawing showing a kind of interference which may occur when performing cooperation MIMO transmission or reception with a distributed network environment according to an exemplary embodiment of the present invention.

FIG. 3A shows a method of allocating a dedicated resource for intra-cluster transmission in Time Division Multiplexing (TDM).

FIG. 3B shows a method of allocating a dedicated resource for intra-cluster transmission in Frequency Division Multiplexing (FDM).

FIG. 3C shows a method of allocating a dedicated resource for intra-cluster transmission in Code Division Multiplexing (CDM).

FIG. 4A is a drawing showing that the dedicated resource for intra-cluster transmission uses a licensed band and FIG. 4B is a drawing showing that the dedicated resource for intra-cluster transmission uses a temporarily licensed/unlicensed band.

FIG. 5 is a drawing showing a method of controlling interference based on proximity according to an exemplary embodiment of the present invention.

FIG. 6 is a drawing showing a location based scheduling method using a three-dimensional coordinate according to an exemplary embodiment of the present invention.

FIG. 7 is a drawing showing a location based scheduling method using CQI (Channel Quality Indicator) according to another exemplary embodiment of the present invention.

FIG. 8 is a drawing showing a method in which a slave terminal selects an operating mode according to an exemplary embodiment of the present invention.

FIG. 9 is a drawing showing an inter-cluster interference situation which is generated when intra-cluster transmission is performed using the same resource between clusters.

FIG. 10 is a drawing showing a method of alleviating interference by a multi-cluster configuration according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the specification, a terminal may be a mobile terminal (MT), a mobile station (MS), an advanced mobile station (AMS), a high reliability mobile station (HR-MS), a subscriber station (SS), a portable subscriber station (PSS), an access terminal (AT), a user equipment (UE), or the like, and may include all or some of the functions of the terminal, the MT, the AMS, the HR-MS, the SS, the PSS, the AT, the UE, or the like.

In addition, a base station (BS) may be an advanced base station (ABS), a high reliability base station (HR-BS), a node B, an evolved node B (eNodeB), an access point (AP), a radio access station (RAS), a base transceiver station (BTS), a mobile multi-hop relay (MMR)-BS, a relay station (RS) serving as the base station, a high reliability relay station (HR-RS) serving as the base station, or the like, and may include all or some of the functions of the ABS, the nodeB, the eNodeB, the AP, the RAS, the BTS, the MMR-BS, the RS, the HR-RS, or the like.

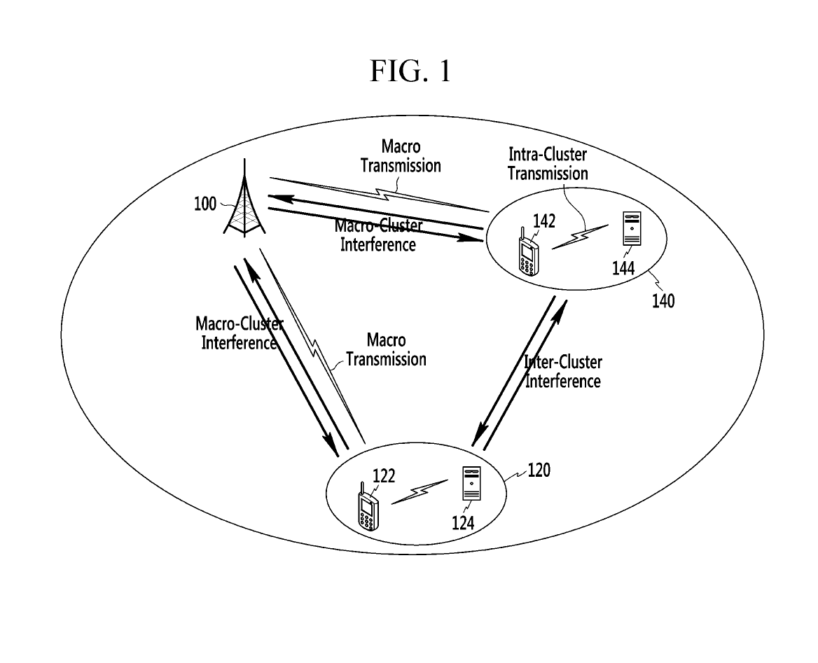

FIG. 1 is a drawing showing a kind of interference which may occur when performing cooperation MIMO transmission or reception with a cellular network environment according to an exemplary embodiment of the present invention.

In order to perform the cooperation MIMO transmission or reception, a plurality of terminals gather to configure a cluster. A cluster 120 includes a plurality of terminals 122 and 124, which cooperate with each other to communicate with a base station 100. A cluster 140 also includes a plurality of terminals 142 and 144, which cooperate with each other to communicate with the base station 100. The plurality of terminals included in the respective clusters 120 and 140 may be classified into master terminals 122 and 142, and slave terminals 124 and 144. The master terminals 122 and 142 are the terminals performing transmission or reception, and the slave terminals 124 and 144 are the terminals cooperating with the master terminals 122 and 142.

In FIG. 1, a cooperation MIMO transmitting or receiving process between the base 100 and the clusters 120 and 140 is defined as macro transmission, and a cooperation MIMO transmitting or receiving process between the cluster 120 and the cluster 140 is defined as inter-cluster transmission. In addition, a sharing process for transmitted or received data within the cluster is defined as intra-cluster transmission.

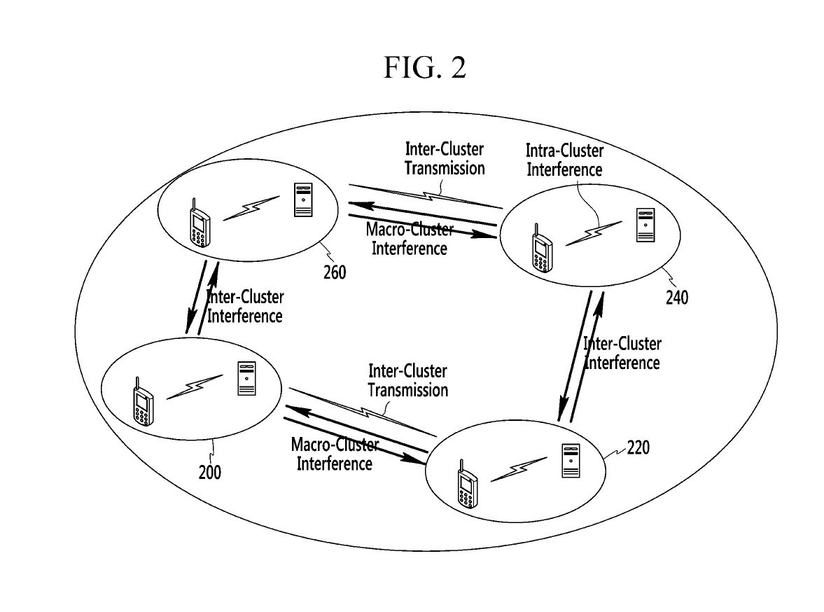

FIG. 2 is a drawing showing a kind of interference which may occur when performing cooperation MIMO transmission or reception with a distributed network environment according to an exemplary embodiment of the present invention.

The distributed network environment does not represent an environment in which the terminal communicates with the base station, but a direct communication environment in which the terminal communicates with the terminal. Also in the distributed network environment, in order to perform the cooperation MIMO transmission or reception, a plurality of terminals gather to configure clusters 200 to 260. In addition, the plurality of terminals configuring each of the clusters 200 to 260 are classified into the master terminal and the slave terminal.

Also in FIG. 2, the cooperation MIMO transmitting or receiving process between the clusters is defined as inter-cluster transmission. That is, the inter-cluster transmission is performed between the cluster 200 and the cluster 220, and the inter-cluster transmission is performed between the cluster 240 and the cluster 260. In addition, the sharing process for transmitted or received data within the respective clusters 220 to 260 is defined as intra-cluster transmission.

In FIGS. 1 and 2, in the case in which a radio resource used for macro transmission or inter-cluster transmission is reused for intra-cluster transmission, macro-cluster interference occurs. In addition, in the case in which a plurality of clusters perform the intra-cluster transmission using the same resource, inter-cluster interference occurs.

First, a method of alleviating the macro-cluster interference will be described.

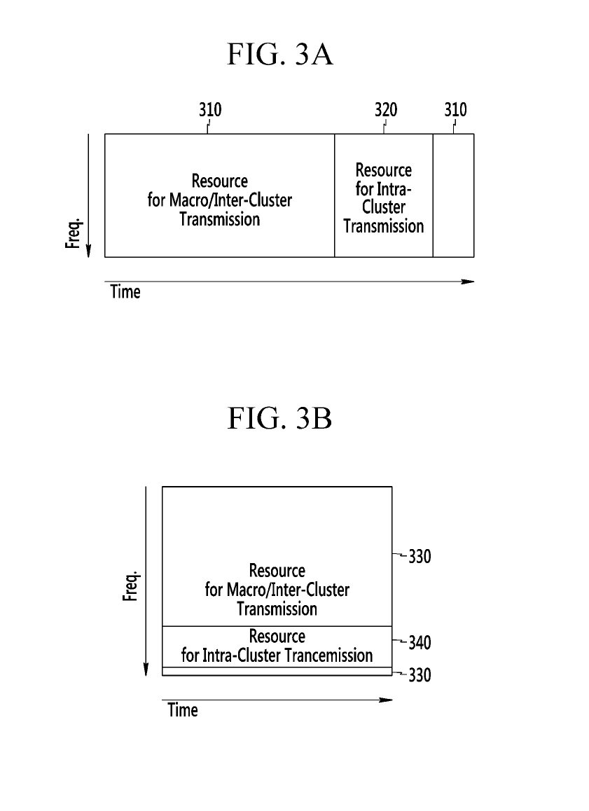

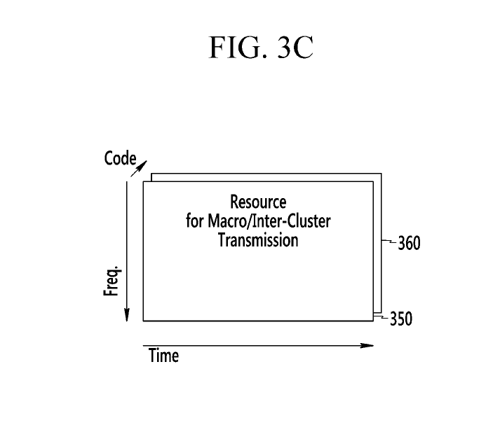

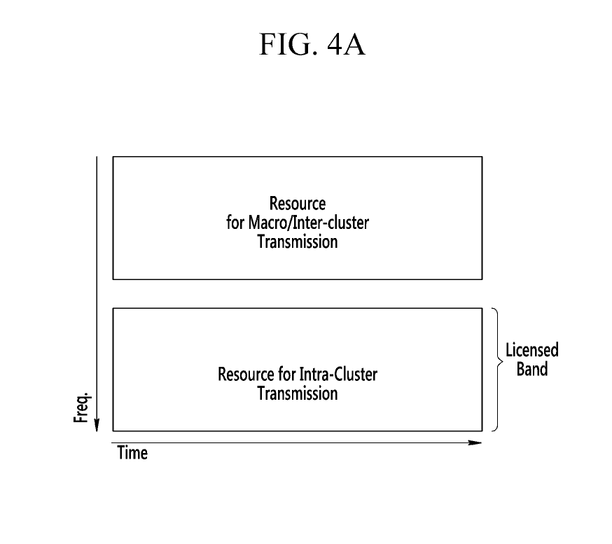

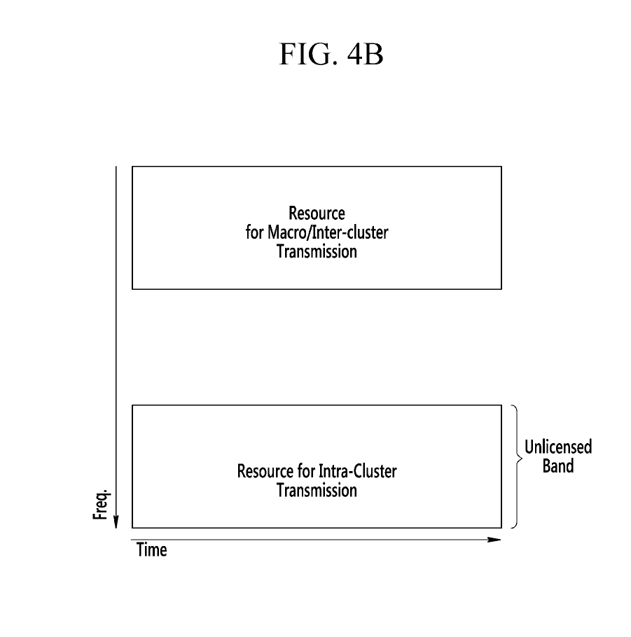

An example of the method of alleviating the macro-cluster interference includes a method of allocating a dedicated resource for intra-cluster transmission. As such, Methods of using the dedicated resource will be described with reference to FIGS. 3A to 3C and FIGS. 4A to 4C.

As shown in FIGS. 3A to 3C, as the dedicated resource for intra-cluster transmission, a part of the resource for macro transmission or inter-cluster transmission is allocated. That is, methods of allocating the resource shown in FIGS. 3A to 3C are in-band allocation methods.

FIG. 3A shows a method of allocating a dedicated resource for intra-cluster transmission in Time Division Multiplexing (TDM). As shown in FIG. 3A, a dedicated resource 310 for macro transmission or inter-cluster transmission and a resource 320 for intra-cluster transmission are divided according to time.

FIG. 3B shows a method of allocating a dedicated resource for intra-cluster transmission in Frequency Division Multiplexing (FDM). As shown in FIG. 3B, a dedicated resource 330 for macro transmission or inter-cluster transmission and a resource 340 for intra-cluster transmission are divided according to a frequency.

FIG. 3C shows a method of allocating a dedicated resource for intra-cluster transmission in Code Division Multiplexing (CDM). As shown in FIG. 3C, a dedicated resource 340 for macro transmission or inter-cluster transmission and a resource 350 for intra-cluster transmission are divided according to a code.

Meanwhile, the dedicated resource for macro transmission or inter-cluster transmission and the resource for intra-cluster transmission may be allocated in a hybride form in which the TDM, the FDM, and the CDM are combined.

FIG. 4A is a drawing showing that the dedicated resource for intra-cluster transmission uses a licensed band and FIG. 4B is a drawing showing that the dedicated resource for intra-cluster transmission uses a temporarily licensed/unlicensed band. As shown in FIGS. 4A and 4B, the dedicated resource for intra-cluster transmission is allocated separately from the resource for macro transmission or inter-cluster transmission in an out-band method, and may use the licensed band or the temporarily licensed/unlicensed band.

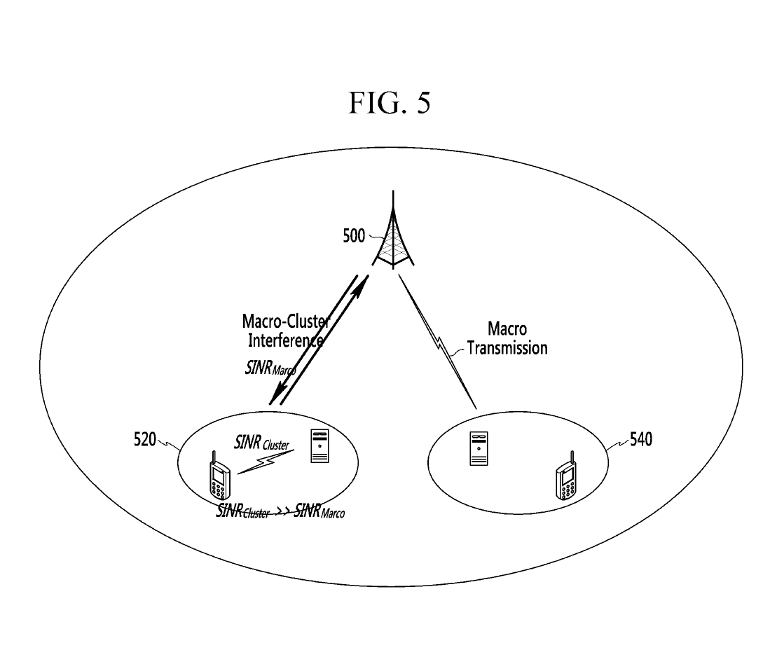

An example of another method of alleviating the macro-cluster interference includes a method of configuring a cluster based on proximity. As such, the method of configuring the cluster based on proximity will be described with reference to FIG. 5.

FIG. 5 is a drawing showing a method of controlling interference based on proximity according to an exemplary embodiment of the present invention.

In FIG. 5, a base station 500 and a cluster 540 use a macro transmission resource to perform the cooperation MIMO transmission or reception. In addition, a cluster 520 performs intra-cluster transmission by reusing the macro transmission resource between the base station 500 and the cluster 540. Thereby, macro-cluster interference occurs between the base station 500 and the cluster 520. However, in this environment, in the case in which signal to interference plus noise ratio (SINR_{Cluster}) between the terminals within the cluster 520 is larger than signal to interference plus noise ratio (SINR_{Macro}) between the base station 500 and the cluster 520, the macro-cluster interference may be ignored based on proximity. Since a method of calculating signal to interference plus noise ratio (SINR) is well known to those skilled in the art, a detailed description thereof will be omitted.

In other words, in the case in which the cluster is configured so that the master terminal and the slave terminal satisfy a condition of the following Equation 1 based on proximity, the macro-cluster interference may be reduced.

SINR_{Cluster}−SINR_{Macro}>Th [Equation 1]

In Equation 1, Th represents a threshold for satisfying a cluster configuring condition and may be differently set to an optimal threshold depending on a network environment. Here, the master terminal and the slave terminal may alleviate interference by adjusting transmission power for data shared therebetween in a range of satisfying the threshold.

Meanwhile, although FIG. 5 shows only the cellular environment, in the distributed environment, the base station in FIG. 5 is replaced with the cluster and the macro-cluster interference occurs by the inter-cluster transmission.

Next, a method of alleviating the inter-cluster interference will be described.

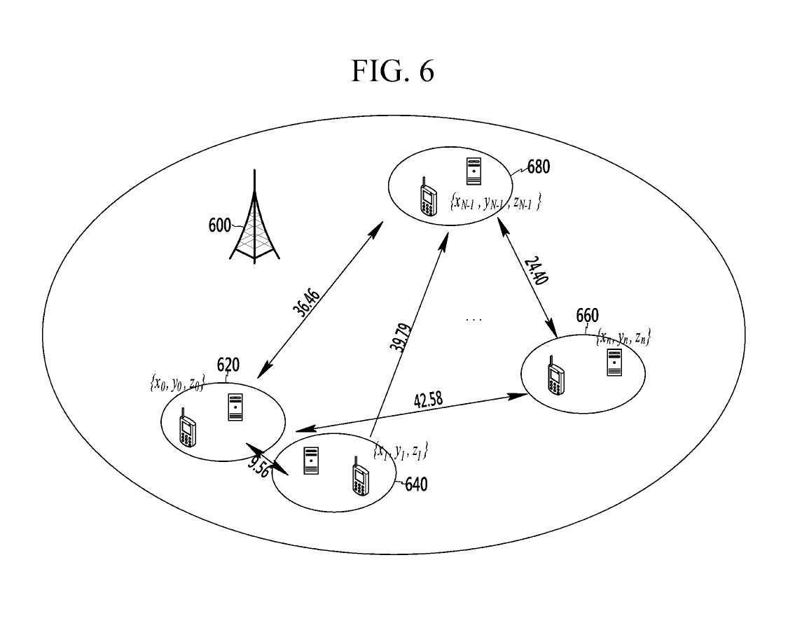

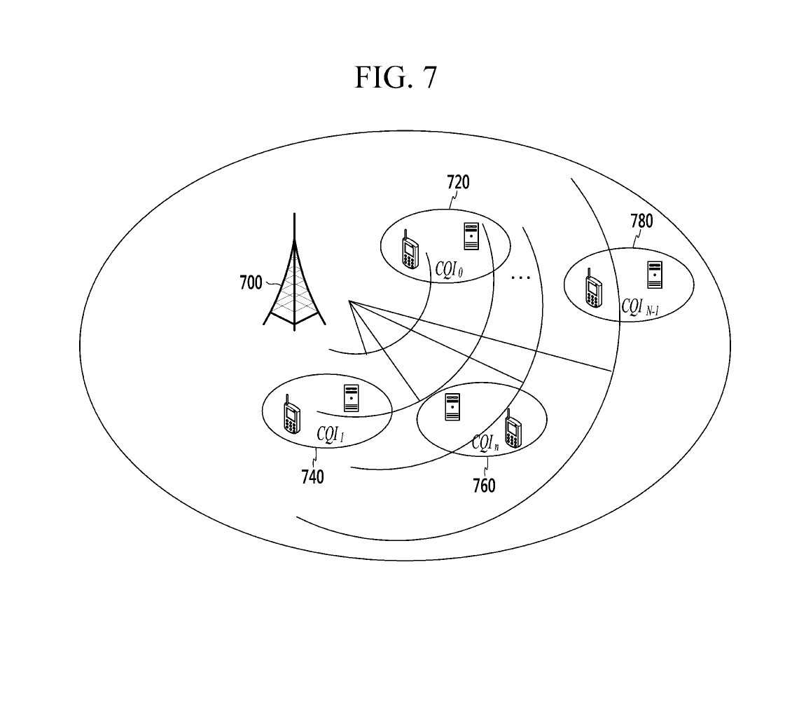

A first method of alleviating the inter-cluster interference is a location based scheduling method (resource allocating method). The above-mentioned location based scheduling method will be described with reference to FIGS. 6 and 7.

The master terminal and the slave terminal configuring the cluster share transmitted or received data in the cluster in order to perform the cooperation MIMO transmission or reception with the base station or another cluster. In this case, in order to reserve a capacity increase effect by the cooperation MIMO transmission or reception, the resource used for intra-cluster transmission may be reused for several clusters. Thereby, the inter-cluster interference occurs. In the case in which clusters performing the intra-cluster transmission using the same resource are far away from each other, the inter-cluster interference may be ignored.

Assume that N master terminals prepare the cooperation MIMO transmission or reception together with the respective slave terminals in any region of the base station. In this case, when the base station allocates the resource for intra-cluster transmission to K clusters, location information of each cluster becomes an input variable determining a scheduling (resource allocating) priority of each cluster. As a method of obtaining the location information of the cluster by the base station, global positioning system (GPS) of the master terminal or the slave terminal may be used, or relative location information based on the base station, or the like may be used. In addition, as the method of obtaining the location information of the cluster by the base station, feedback information such as received signal strength indicator (RSSI), channel quality indicator (CQI), or the like of the master terminal or the slave terminal may be used. In the case in which the slave terminal is stationary, the base station may detect location information of the slave terminal in advance and may use the detected location information. Since the methods as described above are well known to those skilled in the art, a detailed description thereof will be omitted and other methods (a location tracking method using an access point of WiFi, etc.) other than those mentioned above may be used.

The base station may estimate the location information of the cluster using the method of obtaining the location information as described above and may represent the estimated location information in one dimensional or two or more dimensional coordinate value. In the case in which N clusters are present in the region of the base station and the estimated location information of an n-th cluster is Cₙ, a scheduling priority Pₙ of the n-th cluster may be determined as in the following Equation 2.

Pₙ=F_{P}(C₀, C₁, . . . , C_{N-1}) [Equation 2]

In Equation 2, F_{P}(•) represents a priority function. In general, the base station determines the priority using quality of service (QoS), average throughput, instant throughput, or the like, but according to an exemplary embodiment of the present, the location information of the cluster is used. Here, the base station sets a higher priority to clusters which are more adjacent to each other among the clusters. The clusters having the high priority are preferentially allocated with resources which are different from each other and therefore, even in the case in which they are adjacent to each other, the interference does not occur.

FIG. 6 is a drawing showing a location based scheduling method using a three-dimensional coordinate according to an exemplary embodiment of the present invention and FIG. 7 is a drawing showing a location based scheduling method using CQI (Channel Quality Indicator) according to another exemplary embodiment of the present invention.

As shown in FIG. 6, a base station 600 obtains three-dimensional (3D) coordinates of the respective clusters 620 to 680 using GPS information, or the like of the master terminals or the slave terminals. In FIG. 6, a 3D location coordinate of the cluster 660 is indicated by {xₙ, yⁿ, xₙ}. The base station 600 may estimate location information between the clusters using a location coordinate of each cluster and in FIG. 6, the estimated location information is indicated by the numbers (9.56, 36.46, etc.). The base station 600 applies the estimated location information to the priority function such as Equation 2 to thereby determine a scheduling priority of each cluster.

The base station 600 allocates the resource for intra-cluster transmission to each of the plurality of clusters 620 to 680 based on the determined priority. For example, as shown in FIG. 6, a distance between the cluster 620 and the cluster 640 is 9.56 and a distance between the cluster 620 and the cluster 660 is 42.58. In this case, the base station 600 allocates a high priority to the cluster 620 and the cluster 640 and allocates a low priority to the cluster 660. That is, the resource for the cluster 620 (the resource for intra-cluster transmission) and the resource for the cluster 640 (the resource for intra-cluster transmission) may be allocated with different values, and the cluster 660 may be allocated with the same resource as that of the cluster 620 or the cluster 640 in order to reuse the resource. Since the cluster 620 and the cluster 640 which are adjacent to each other are allocated with different resources from each other, the inter-cluster interference does not occur. In addition, even though the cluster 620 or the cluster 640 and the cluster 660 are allocated with the same resource, a distance between the cluster 620 or the cluster 640 and the cluster 660 is increased, such that the inter-cluster interference is alleviated.

As shown in FIG. 7, a base station 700 obtains channel quality indicator (CQI) as feedback information of the master terminals or the slave terminals. In FIG. 7, CQI of a cluster 760 is indicated by CQIₙ. The base station 700 may estimate location information between the clusters using CQI information of each cluster. Since a method in which the base station obtains the position information between the clusters using the CQI information is well known to those skilled in the art, a detailed description thereof will be omitted. The base station 700 applies the location information which is estimated using CQI to the priority function such as Equation 2 to thereby determine a scheduling priority of each cluster. In addition, the base station 700 allocates the resource for intra-cluster transmission to each of the plurality of clusters 720 to 780 based on the determined priority. Since a method in which the base station 700 allocates the resource based on the determined priority is the same as that of FIG. 6, a detailed description thereof will be omitted.

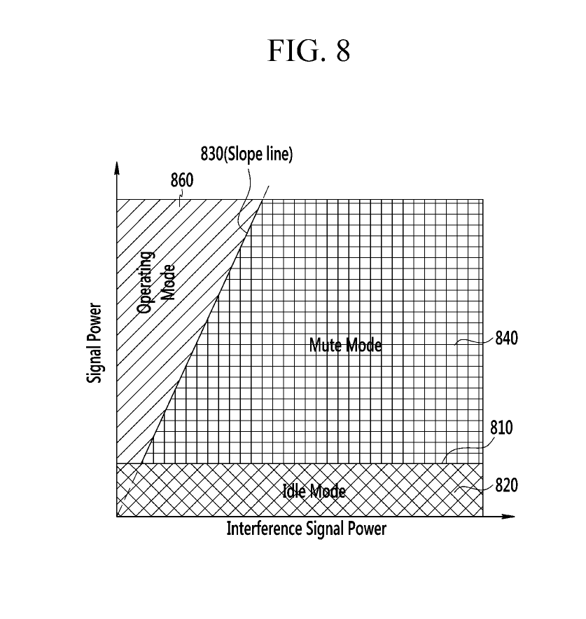

A second method of alleviating the intra-cluster interference is a method in which the slave terminal selects an operating mode. All selections of the slave terminal as mentioned above will be described with reference to FIG. 8.

In the case in which the master terminals are densely distributed in a specific region and each mater terminal configures the cluster with the slave terminal, since a distance between the clusters is not distant, the inter-cluster interference occurs. The slave terminal selects the operating mode based on a circumstance interference situation, thereby making it possible to alleviate the inter-cluster interference.

FIG. 8 is a drawing showing a method in which a slave terminal selects an operating mode according to an exemplary embodiment of the present invention. In FIG. 8, a horizontal axis (Interference Signal) indicates strength of an interference signal received by the slave terminal and a vertical axis (Signal Power) indicates strength of a signal received by the slave terminal from the master terminal.

The slave terminal according to the exemplary embodiment of the present invention determines whether or not the cluster is configured based on an interference situation, in the case in which a cluster configuration request is received from the mater terminal.

As shown in FIG. 8, in the case in which the strength of the signal from the master terminal is a predetermined level 810 or less, the slave terminal maintains an idle mode. That is, in the case in which the strength of the signal received from the master terminal is a predetermined level 810 or less, the slave terminal does not configure the cluster with the master terminal and maintains the idle mode.

In the case in which a ratio of signal strength from the master terminal and strength of an interference signal is a threshold 830 or more, the slave terminal performs an operating mode. That is, in the case in which the ratio of signal strength from the master terminal and strength of the interference signal is the threshold 830 or more, the slave terminal configures the cluster with the master terminal and performs the cooperation MIMO transmission or reception.

In addition, in the case in which the ratio of signal strength from the master terminal and strength of the interference signal is the threshold 830 or less, the slave terminal performs a mute mode. That is, in the case in which the ratio of signal strength from the master terminal and strength of the interference signal is the threshold 830 or less, the slave terminal does not configure the cluster with the master terminal.

In FIG. 8, the ratio of signal strength from the master terminal and strength of the interference signal may be indicated by a slope line such as 830 and the slop line may become the threshold. An optimal threshold may be set to be different depending on a network environment and the slope line 830 may be set as a curved line which is expressed by a quadratic equation or more as well as a straight line which is expressed by a linear equation.

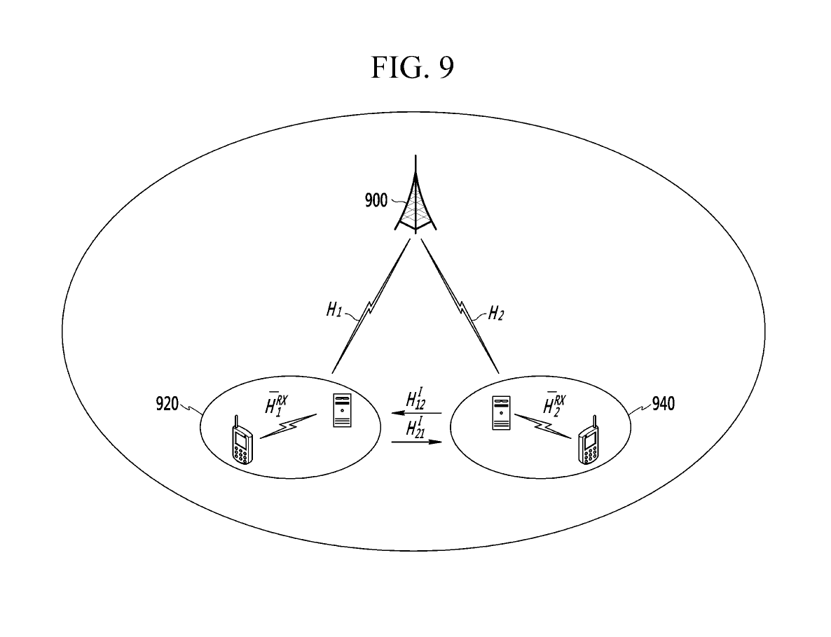

A third method of alleviating the inter-cluster interference is a beamforming or precoding method. The above-mentioned beamforming or precoding method will be described with reference to FIG. 9.

FIG. 9 is a drawing showing an inter-cluster interference situation which is generated when intra-cluster transmission is performed using the same resource between clusters.

In FIG. 9, a symbol which is transmitted to a cluster 920 by a base station 900 is defined as X₁ and a symbol which is transmitted to a cluster 940 by the base station 900 is defined as X₂. In addition, a channel between the base station 900 and the cluster 920 is defined as H₁ and a channel between the base station 900 and the cluster 940 is defined as H₂. Channels between the cluster 920 and the cluster 940 are respectively defined as H^{I}₁₂ and H^{I}₂₁, a channel in the cluster 920 is defined as H̅₁^{Rx}, and a channel in the cluster 940 is defined as H̅₂^{Rx}. In this case, a received signal Y₁ of the cluster 920 and a received signal Y₂ of the cluster 940 may be expressed by the following Equation 3.

$$[ \begin{matrix}{Y}_{1} \\ {Y}_{2}\end{matrix} ] = [ \begin{matrix}{\overline{H}}_{1}^{Rx} {H}_{1} & {H}_{12}^{I} {\overline{H}}_{2}^{Rx} {H}_{2} \\ {H}_{21}^{I} {\overline{H}}_{1}^{Rx} {H}_{1} & {\overline{H}}_{2}^{Rx} {H}_{2}\end{matrix} ] [ \begin{matrix}{X}_{1} \\ {X}_{2}\end{matrix} ] + [ \begin{matrix}{W}_{1} \\ {W}_{2}\end{matrix} ] \qquad [ Equation 3 ]$$

In Equation 3, W is additive circular symmetric white Gaussian noise (AWGN). An interference signal in the cluster 920 becomes H₁₂^{I} H̅₂^{Rx}H₂X₂ and an interference signal in the cluster 940 becomes H₂₁^{I} H̅₁^{Rx}H₁X₁.

Once Equation 3 is expanded to N clusters, a received symbol Y of each cluster may be expressed by the following Equation 4.

$$Y = HX + W = [ \begin{matrix}{Y}_{1} \\ {Y}_{2} \\ ⋮ \\ {Y}_{N}\end{matrix} ] [ \begin{matrix}{\overline{H}}_{1}^{Rx} {H}_{1} & {H}_{12}^{I} {\overline{H}}_{2}^{Rx} {H}_{2} & … & {H}_{1 N}^{I} {\overline{H}}_{N}^{Rx} {H}_{N} \\ {H}_{21}^{I} {\overline{H}}_{1}^{Rx} {H}_{1} & {\overline{H}}_{2}^{Rx} {H}_{2} & & \\ ⋮ & & ⋱ & \\ {H}_{N 1}^{I} {\overline{H}}_{1}^{Rx} {H}_{1} & & & {\overline{H}}_{N}^{Rx} {H}_{N}\end{matrix} ] [ \begin{matrix}{X}_{1} \\ {X}_{2} \\ ⋮ \\ {X}_{N}\end{matrix} ] + [ \begin{matrix}{W}_{1} \\ {W}_{2}\end{matrix} ] \qquad [ Equation 4 ]$$

Therefore, an MIMO symbol multiplied by a beamforming or precoding matrix P which maximizes SINR or capacity of the received signal is transmitted based on a channel matrix H in Equation 4, such that the interference may be controlled. In this case, a received symbol matrix Y is expressed by the following Equation 5.

Y=HPX+W [Equation 5]

A beamforming or precoding matrix P is a function of H, and as a matrix generating method, the matrix generating method which is used in an existing known MIMO transmitting or receiving method may be applied.

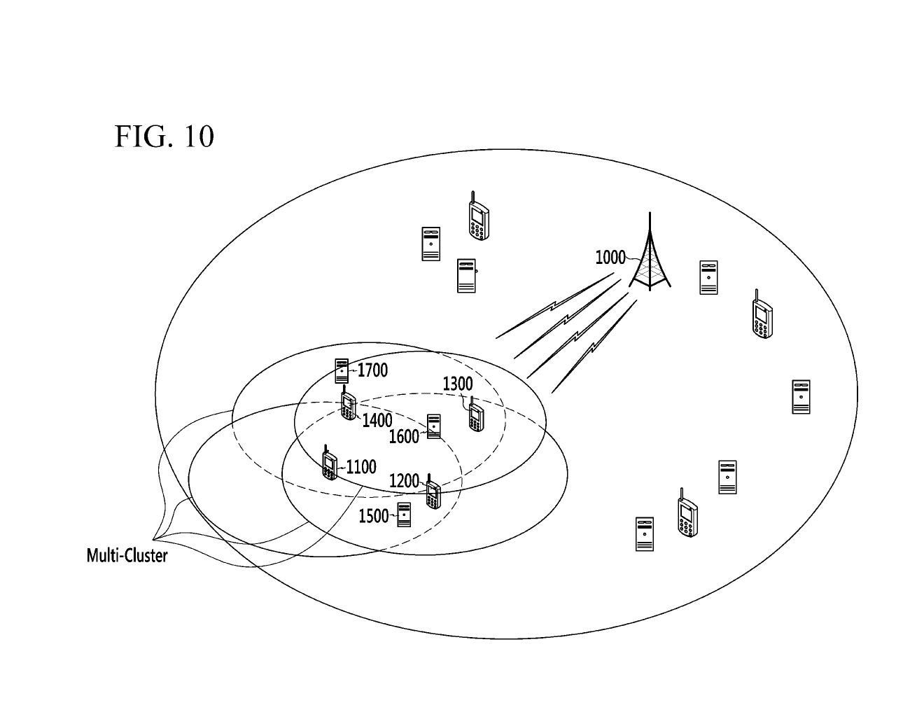

A fourth method of alleviating the inter-cluster interference is a multi-cluster MIMO transmitting method. The above-mentioned multi-cluster transmitting method will be described with reference to FIG. 10.

FIG. 10 is a drawing showing a method of alleviating interference by a multi-cluster configuration according to an exemplary embodiment of the present invention.

In the case in which the master terminals are densely distributed in a specific region and each mater terminal configures the cluster with the slave terminal, since a distance between the clusters is not distant, the inter-cluster interference occurs.

As shown in FIG. 10, the slave terminals which are densely distributed in the specific region do not configure the cluster with one master terminal, but configure the cluster with two or more master terminals. In addition, in order to perform a multiple access between the respective master terminals configuring the multi-cluster with the slave terminal, spatial division multiple access (SDMA) is used, thereby making it possible to alleviate the inter-cluster interference. For example, as shown in FIG. 10, each of three slave terminals 1500, 1600, and 1700 configures a multi-cluster with four master terminals 1100 to 1400. In this case, in the case in which an MIMO spatial resource (stream or layer) is allocated for each master terminal, the inter-cluster interference disappears between the master terminals and the slave terminal which configure the multi-cluster.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of transmitting or receiving first data to be transmitted to a first apparatus or to be received from the first apparatus using cooperation communication by a first terminal, the method comprising:
calculating a first signal to interference plus noise ratio (SINR), which is SINR between the first terminal and the first apparatus;
calculating a second SINR, which is SINR between at least one second terminal and the first terminal performing the cooperation communication; and
forming a first cluster with the second terminal to perform the cooperation communication when the second SINR is higher than the first SINR by a predetermined threshold or more.

2. The method of claim 1, wherein:
the forming of the first cluster includes adjusting transmission power of the first data so that the second SINR is higher than the first SINR by the threshold or more.

3. The method of claim 2, further comprising:
sharing the first data with the second terminal at the adjusted transmission power.

4. The method of claim 1, wherein:
the first apparatus is a base station to which the first terminal and the second terminal belong.

5. The method of claim 4, wherein:
the first terminal reuses a resource for communication between a second cluster and the base station in order to communicate with the second terminal, and
the second cluster belongs to the base station and is a cluster which is different from the first cluster.

6. The method of claim 1, wherein:
the first apparatus is a second cluster which is different from the first cluster, and the first cluster and the second cluster form a distributed environment.

7. A method of allocating resources to a plurality of clusters performing cooperation communication by a base station, the method comprising:
estimating location information for each of the plurality of clusters;
determining a priority for each of the plurality of clusters based on the estimated location information; and
allocating a resource for inter-cluster transmission to each of the plurality of clusters based on the priority.

8. The method of claim 7, wherein:
the determining of the priority includes setting a higher priority to clusters which are more adjacent to each other among the plurality of clusters.

9. The method of claim 8, wherein:
the allocating of the resources includes
allocating different resources to a first cluster and a second cluster and allocating the same resource as that of the first cluster or the second cluster to a third cluster when a distance between the first cluster and the second is closer than a distance between the first cluster and the third cluster.

10. The method of claim 7, wherein:
the estimating of the location information includes estimating the location information for each of the plurality of clusters using global positioning system (GPS) information or channel quality indicator (CQI) information of terminals belonging to each of the plurality of clusters.

11. The method of claim 7, wherein:
each of the plurality of clusters performs the cooperation communication by sharing data to be transmitted to the base station or to be received from the base station between terminals belonging to a cluster.

12. A method of operating a second terminal performing cooperation communication with a first terminal, the method comprising:
measuring a first value which is strength of a signal received from the first terminal;
measuring a second value which is strength of an interference signal received by the second terminal; and
performing the cooperation communication when a ratio of the first value and the second value is a predetermined threshold or more.

13. The method of claim 12, further comprising:
not performing the cooperation communication when the first value is a predetermined value or less.

14. The method of claim 13, further comprising:
not performing the cooperation communication when the ratio of the first value and the second value is the predetermined threshold or less.

15. The method of claim 12, wherein:
the threshold is set to be different depending on a network environment.
